(19) United States
(12) Patent Application Publication
(10) Pub. No.: US 2005/0063627 A1
(43) Pub. Date: Mar. 24, 2005

(54) Rolling element retainer and rolling bearing assembly using the same

(75) Inventors: Keiichi Ueda, Kuwana-shi (JP); Kaoru Ueno, Kuwana-shi (JP); Tadayoshi Yonezawa, Kuwana-shi (JP)

Correspondence Address: STAAS & HALSEY LLP, SUITE 700, 1201 NEW YORK AVENUE, N.W., WASHINGTON, DC, 20005, US

(73) Assignee: NTN Corporation, Osaka (JP)

(21) Appl. No.: 10/942,771

(22) Filed: Sep. 17, 2004

(30) Foreign Application Priority Data
Sep. 19, 2003 (JP) 2003-327702
Dec. 5, 2003 (JP) 2003-407618

(51) Int. Cl. F16C 33/38

(52) U.S. Cl. 384/523

(57) ABSTRACT

To secure a load bearing capability along with a smooth supply and drainage of a lubricant oil into and from a rolling bearing assembly, a retainer and the rolling bearing assembly provided with such retainer are of a design in which the retainer (5) includes an annular wing portion (5a) and a plurality of pillars (5b) extending from circumferential locations of the annular wing portion (5a) and formed with a pocket (6) between the neighboring pillars (5b) for rollingly retaining rolling elements (4) of the rolling bearing assembly. The annular wing portion (5a) has an inner peripheral surface formed to define an inclined annular face (7). This inclined annular face (7) is deployed over a substantially entire width of the annular wing portion (5a) in an axial direction of the retainer (5) and is inclined to flare axially outwardly to have a diameter decreasing towards a mid-center portion of the retainer (5) in the axial direction.

### BACKGROUND OF THE INVENTION

1. Field of the Invention

The present invention relates to a rolling element retainer for a rolling bearing assembly of a kind generally employed in generic industrial machines such as a spindle device for a machine tool, to a rolling bearing assembly utilizing such rolling element retainer and to a lubricating structure for the rolling bearing assembly.

2. Description of the Prior Art

In rolling bearing assemblies, the purpose of lubrication is to prevent a direct metal-to-metal contact in the presence of a thin oil film formed on rolling surfaces and sliding surfaces and, by so doing, the following effects can be obtained:
(1) Minimization of friction and frictional wear,
(2) Purging of heat evolved as a result of friction,
(3) Increase of the lifetime of the rolling bearings,
(4) Prevention of rusting, and
(5) Prevention of foreign matter from being trapped in the rolling bearings.

In order to enhance those effects brought about by lubrication, it is necessary to adopt a lubricating method that is appropriate to the conditions under which the rolling bearings are used. In general, when it comes to the spindle of a machine tool, a very small quantity of a lubricant oil is used to minimize generation of heat resulting from stirring of the lubricant oil and, depending on the condition of use, a grease lubrication, an oil mist lubrication, an air/oil lubrication or a jet lubrication is employed. The relation between the amount of the lubricant oil, the frictional loss and the bearing temperature in the bearing is illustrated in FIG. 17.

The air/oil lubrication (region II in FIG. 17) makes use of a structure in which the lubricant oil, after the amount thereof has been accurately metered, is supplied continuously towards a terminal end of an oil supply tube at an optimum interval for each bearing and is subsequently jetted onto a required site of lubrication through a nozzle so disposed as to confront a bearing. This lubricating method is largely employed as a lubricating method adaptable to increase the spindle speed of the machine tool and lower the temperature rise. A lubricant oil supply system employing the lubricating method discussed above is shown in FIG. 18 and a portion of the rolling bearing assembly, where lubrication is made, is shown in FIG. 19.

The lubricant oil supply system shown in FIG. 18 is of a design in which the lubricant oil metered from a tank 61 and subsequently supplied through an oil passage 62 is mixed with an air supplied through air passages 63 and 64 to provide an air/oil mixture, which is in turn discharged onto a rolling bearing assembly 51 through a nozzle 66 by way of an air/oil line 65. As shown in FIG. 19, the air/oil mixture is discharged towards a raceway surface 52a in an inner race 52 of the rolling bearing assembly 51.

In this lubricating system shown in FIG. 18, since the bearing temperature becomes high during a high speed rotation, the oil pressure forming capability of the lubricant oil tends to be lowered. Also, since an air curtain formed as a result of entanglement of an air around a rotating element increases, the higher the speed of rotation, the severer the lubricating condition, and, therefore, the lubricant oil supplied from the nozzle 66 finds difficulty entering into the rolling bearing assembly 51.

Also, unless oil drainage (purge of the air/oil mixture) takes place smoothly, the lubricant oil will accumulate within the rolling bearing assembly, accompanied by increase of the stirring drag of the lubricant oil, which leads to increase of the temperature rise. If the temperature rise is considerable, the machining precision would be degraded as a result of thermal expansion of the spindle.

In view of the foregoing, for the high speed operation along with lubrication with a minute quantity of the lubricant oil including the air/oil lubrication, the rolling bearing assembly must have the following specifications:
(1) The bearing assembly must have a high oil supply capability (i.e., the lubricant oil can easily enter the bearing assembly), and
(2) The bearing assembly must have a high oil draining capability (i.e., the lubricant oil can be easily drained out of the bearing assembly).

As discussed above, for the high speed operation with the air/oil lubrication, it is important to design the bearing assembly having an enhanced oil supply capability and an enhanced oil draining capability in order to prevent the increase of the temperature rise.

FIGS. 19 and 20 illustrate examples of the specification of the above described lubricating structure for the bearing assembly. By aiming the nozzle 66 at a portion of the bearing assembly where the temperature rise is highest, that is, the raceway surface 52a of the inner race 52 where the lubricant oil is most required, the oiling efficiency is increased. In addition, the outer diameter of one end portion of the inner race 52 adjacent a bearing rear side g (one side where the outer race receives an axially acting load), which is aimed at by the nozzle 66, is reduced to thereby increase the oiling space. In an angular ball bearing assembly, a tapered surface required for the purpose of assemblage, which is referred to as a “counter bore”, is formed in the outer diameter of a portion of the inner race adjacent the bearing rear side g or in the inner diameter of a portion of the outer race adjacent a bearing front side f. Where the counter bore is defined in that portion of the outer diameter of the inner race 52 adjacent the bearing rear side g, the outer diameter of the inner race 52 is reduced to increase the oiling space.

However, where rolling elements 54 are large in size relative to the bearing width, the retainer 55 for retaining the rolling elements 54 must have a width increased to a value about equal to the bearing width. As a result thereof, a portion of the air/oil mixture jetted from the nozzle 66 will collide against the retainer 55, hampering a smooth supply of the lubricant oil. By way of example, a region shown by R in FIG. 21A represents the region in which the supply of the lubricant oil is hampered.

In such case, although it may be possible to lower the aiming position of the nozzle 66, as shown in FIG. 21B, in order to avoid an interference between the retainer 55 and the air/oil mixture jetted from the nozzle, the lowering of the nozzle aiming position renders a spacer 58, disposed next to the inner race 52, to have a reduced outer diameter, that is, to have a reduced wall thickness and, therefore, the lowering of the nozzle aiming position is restricted.

On the other hand, the lubricant oil supplied to the bearing assembly is discharged to the outside of the bearing assembly after having passed through an interior of the bearing assembly and then flown in a manner as shown by the arrows in FIG. 22. In order to increase the oil draining capability, the space (an oil drain passage 5A) defined between the retainer 55 and the outer race 53 and/or the space (an oil drain passage 5B) defined between the retainer 55 and the inner race 52 have to be increased.

In order to enable those spaces to be increased, the outer diameter D (FIG. 23) of that portion of the inner race 52 adjacent the bearing front side f, which defines the oil drain passage 5B, has to be reduced and, at the same time, the inner diameter of the outer race 53 has to be increased. However, since the inner race of the angular ball bearing assembly is used to support the load on a portion of the raceway surface adjacent the bearing front side f (and, hence, has a surface of contact with the rolling elements), reduction of the outer diameter of the inner race leads to reduction in load bearing capability, in particular the axial load bearing capability. Once the load bearing capability is lowered, impressions tend to be easily formed on the raceway surface and the rolling elements due to permanent deformation thereof, causing the generation of abnormal noises and/or increase of vibrations.

Also, in the case of the angular ball bearing assembly, as shown in FIG. 24, the lubricant oil entering from the bearing rear side g as shown by the arrow P is, after having entered from the inner race 72 into a gap between a retainer 75 and rolling elements 74, urged to flow through between the retainer 75 and an outer race 73 by the effect of a centrifugal force, as shown by the arrow Q, and is subsequently discharged from lateral sides of the bearing assembly.

In such angular ball bearing assembly, in order to increase the flow characteristic of the lubricant oil, it has been suggested that an inner peripheral surface of the retainer 75 is so inclined, in contrast to the illustrated case, as to increase gradually towards the rolling elements 74, so that the lubricant oil deposited on the inclined surface can be flown towards the rolling elements 74 by the effect of the centrifugal force.

Where the oil lubrication is effected in the angular ball bearing assembly, it is necessary to suppress heat build-up in the bearing assembly, which would result from stirring drag of the lubricant oil. While the suggested system described above is effective to increase the flow characteristic of the lubricant oil, the gap between the retainer 75 and the outer race 73, which defines an outlet port, is small as is the case with that shown in and described with reference to FIG. 24. Accordingly, the lubricant oil draining capability is insufficient and, therefore, the lubricant oil accumulating within the bearing assembly, when stirred, generates a substantial amount of heat.

### SUMMARY OF THE INVENTION

In view of the foregoing, it is an object of the present invention to provide a rolling element retainer for a rolling bearing assembly, in which a lubricant oil can be smoothly supplied into and discharged from the bearing assembly while securing a sufficient load bearing capacity.

It is another object of the present invention to provide a rolling bearing assembly utilizing the rolling element retainer of the type referred to above.

In order to accomplish these objects of the present invention, there is provided, in accordance with one aspect of the present invention, a retainer for a rolling bearing assembly, which includes an annular wing portion, and a plurality of pillars extending in an axial direction of the retainer from a corresponding number of circumferential locations of the annular wing portion and formed with pockets between the corresponding pillars for rollingly retaining rolling elements of the rolling bearing assembly. The annular wing portion has an inner peripheral surface formed to define an inclined annular face. The inclined annular face is deployed over a first substantially entire width of the annular wing portion in an axial direction of the retainer and is inclined to flare axially outwardly to have a diameter decreasing towards a mid-center portion of the retainer.

The retainer also may have a pair of annular wing portions provided on both sides of the retainer in an axial direction thereof. Also, the inclined annular face may extend from the annular wing portion to the pillars.

The retainer of the structure referred to above is used in a rolling bearing assembly of a type in which an oil lubricating system including, for example, an air/oil lubricating structure or an oil mist lubricating structure is employed. Since this retainer has in its inner peripheral surface the inclined annular face, which is inclined to flare axially outwardly to have a diameter decreasing towards the mid-center portion of the retainer and which is deployed over the substantially entire width of the annular wing portion, oil supply and drain spaces defined by a gap between the inner peripheral surface of the retainer and the outer peripheral surface of the inner race can be increased in size.

The increased oil supply space is advantageous in that even where the rolling elements have a relatively large diameter for a given width of the bearing assembly, an air/oil mixture can be aimed at an inner raceway groove in the inner race by a nozzle, without interfering with the retainer. In such case, the aiming position of the nozzle need not be lowered and, therefore, the wall thickness of an inner race spacer, positioned radially inwardly of the nozzle and held in axial abutment with the inner race, need not be reduced, allowing the inner race spacer to have a sufficient strength. Also, even for the oil drain space defined between the inner peripheral surface of the retainer and the outer peripheral surface of the inner race, there is no need to reduce the outer diameter of the inner race and, hence, the oil drain space can be expanded without being accompanied by reduction of the load bearing capability. For this reason, an undesirable accumulation of the lubricant oil within the bearing assembly can advantageously be suppressed.

The foregoing effects are obtained where the retainer is of a design having the annular wing portions on both sides of the retainer in the axial direction thereof. However, where the retainer is of a design having the annular wing portion only on one side of the retainer in the axial direction thereof, either the oil supply space or the oil drain space can be increased in size.

As hereinabove described, where the retainer of the above described structure is employed, the oil supply and draining capabilities of the rolling bearing assembly can advantageously be enhanced with no limit imposed on the design of the outer diameter of each of the inner race spacer and the inner race. Because of this, increase of the operating reliability due to suppression of an undesirable temperature rise and, hence, a high speed operation due to a low increase of the temperature can be attained. Accordingly, the load bearing capability of the rolling bearing assembly can advantageously be secured.

Also, the inclined annular face is preferably inclined at an angle within the range of 10 to 20°. If the inclination angle is smaller than the lowermost limit of 10°, the oil supply space and the oil drain space make no difference with those employed in the conventional retainer having no inclined annular faces and, therefore, it is quite difficult to increase the oil supply and draining efficiencies. Conversely, if the inclination angle exceeds the uppermost limit of 20°, by reason of the necessity to secure a sufficient wall thickness of the retainer it would be difficult to form the inclined annular face which extends from the annular wing portion to the pillars and, therefore, it is difficult to expand the oil supply space and the oil drain space.

In the retainer referred to above, the proportion of width of the inclined annular face relative to the width of the retainer may be 30% or more. If the proportion of the width of the inclined annular face relative to the width of the retainer is smaller than 30%, the oil supply space and the oil drain space make no difference with those employed in the conventional retainer having no inclined annular faces and, therefore, it is quite difficult to increase the oil supply and draining efficiencies.

The present invention in accordance with another aspect thereof provides a rolling bearing assembly, which includes an outer race, an inner race positioned inside the outer race, a circular row of rolling elements rollingly interposed between the outer race and the inner race, and a retainer for rollingly retaining the rolling elements. The retainer used in this rolling bearing assembly is of the structure defined in accordance with the first aspect of the present invention discussed above. With this rolling bearing assembly, similar advantages to those described in connection with the retainer of the present invention can be equally appreciated.

The present invention in accordance with a further aspect thereof also provides a lubricating structure for use in a rolling bearing assembly, including the rolling bearing assembly which includes an outer race, an inner race positioned inside the outer race, a circular row of rolling elements rollingly interposed between the outer race and the inner race, and a retainer for rollingly retaining the rolling elements, and a nozzle member for injecting a lubricant oil such as an air/oil mixture or an oil mist in between the inner peripheral surface of the retainer and the outer peripheral surface of the inner race. The retainer employed in this rolling bearing assembly is of the structure defined in accordance with the first aspect of the present invention discussed above. With this lubricating structure, similar advantages to those described in connection with the retainer of the present invention can be equally appreciated.

The present invention in accordance with a still further aspect thereof also provides an angular ball bearing assembly, which includes an outer race having an outer raceway groove defined in an inner peripheral surface thereof, an inner race positioned inside the outer race and having an inner raceway groove defined in an outer peripheral surface thereof, a circular row of rolling elements rollingly received in part within the outer raceway groove and in part within the inner raceway groove, and a retainer interposed between the outer and inner races for rollingly retaining the rolling elements. In this angular ball bearing assembly, at least one of a shoulder portion of the inner peripheral surface of the outer race on one side of the outer raceway groove adjacent a rear side thereof and a portion of an outer peripheral surface of the retainer on one side of each pocket adjacent a rear side of the outer race is formed to define an annular tapered surface area flaring axially outwardly towards an annular open end of the outer race, with the diameter of the tapered surface area increasing towards the annular open end of the outer race.

According to this still further aspect of the present invention, if the shoulder portion of the inner peripheral surface of the outer race on one side of the outer raceway groove adjacent the rear side thereof is formed to define the annular tapered surface area with a diameter increasing towards the annular open end of the outer race, a gap delimited between the outer race and the retainer can be increased in size at the rear side of the outer race where it is difficult to secure a gap and, therefore, the lubricant oil can easily be drained through this gap. For this reason, the amount of the lubricant oil accumulating within the bearing assembly and tending to be stirred can advantageously be minimized to thereby suppress the heat generation which would otherwise result from the stirring of the lubricant oil. Accordingly, the operating reliability can advantageously be increased and the load bearing capability can also be secured.

On the other hand, if that portion of the outer peripheral surface of the retainer on one side of each pocket adjacent the rear side of the outer race is formed to define the annular tapered surface area with a diameter increasing towards the annular open end of the outer race, the outer diameter of the widthwise intermediate portion on the outer peripheral surface of the retainer can be reduced to increase a gap delimited between the outer race and the retainer at the rear side of the outer race and, therefore, the lubricant oil can easily be drained through this gap. For this reason, the amount of the lubricant oil accumulating within the bearing assembly and tending to be stirred can advantageously be minimized to thereby suppress the heat generation which would otherwise result from the stirring of the lubricant oil. Accordingly, the operating reliability can advantageously be increased and the load bearing capability can also be secured.

The angular ball bearing assembly referred to above in accordance with the still further aspect of the present invention may be used for rotatably supporting a spindle of a machine tool spindle device. As is well known to those skilled in the art, the machine tool spindle is required to operate at a high speed so that the machining efficiency can be increased and, also, in order to increase the machining precision, it is necessary to suppress the heat generation from the bearing assembly as low as possible. For this reason, the effect of suppressing the heat generation possessed by the angular ball bearing assembly of the present invention can be effectively demonstrated and, while the heat generation is suppressed, the spindle is allowed to rotate at a high speed.

The angular ball bearing assembly according to the above described still further aspect of the present invention may be provided with the nozzle member. In this case, the nozzle member is disposed on a front side of the angular ball bearing assembly for supplying a lubricant oil onto the outer peripheral surface of the inner race. The nozzle member may be provided on either the rear side or the front side of the bearing assembly.

According to the combined use of the angular ball bearing assembly and the nozzle member, the lubricant oil supplied from the nozzle member can be blown to the outer peripheral surface of the inner race of the angular ball bearing assembly and, hence, the lubricant oil can be efficiently supplied into the bearing assembly. In addition, by the effects of the present invention hereinbefore described, the lubricant oil can also be effectively drained from the bearing assembly. Accordingly, while the heat generation resulting from the stirring of the lubricant oil is effectively suppressed, the lubricity of the bearing assembly can be increased.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary longitudinal sectional view of a rolling bearing assembly according to a first preferred embodiment of the present invention;

FIG. 2A is a fragmentary longitudinal sectional view of a rolling element retainer employed in the rolling bearing assembly shown in FIG. 1;

FIG. 2B is a fragmentary plan view of the rolling element retainer of FIG. 2A, showing an inner peripheral surface thereof;

FIG. 3 is a fragmentary longitudinal sectional view of an air/oil lubricating structure utilizing the rolling bearing assembly;

FIG. 4 is a graph showing a propensity of temperature increase in an outer race relative to the rotational speed, which is exhibited by the rolling bearing assembly according to the first embodiment of the present invention, as compared with that exhibited by the conventional rolling bearing assembly;

FIG. 5 is a fragmentary longitudinal sectional view of a modified form of the air/oil lubricating structure utilizing the rolling bearing assembly;

FIG. 6 is a fragmentary sectional view showing a portion of the rolling bearing assembly of FIG. 5 on an enlarged scale;

FIG. 7 is a fragmentary longitudinal sectional view of an angular ball bearing assembly according to a second preferred embodiment of the present invention;

FIG. 8 is a fragmentary sectional view of an important portion of the angular ball bearing assembly of FIG. 7 on an enlarged scale;

FIG. 9 is a fragmentary longitudinal sectional view of the angular ball bearing assembly provided with a nozzle in accordance with a third preferred embodiment of the present invention;

FIG. 10 is a longitudinal sectional view of a spindle device utilizing the angular ball bearing assembly shown in FIG. 7;

FIG. 11 is a fragmentary longitudinal sectional view of the angular ball bearing assembly according to a fourth preferred embodiment of the present invention;

FIG. 12 is a fragmentary longitudinal sectional view of an important portion of the angular ball bearing assembly of FIG. 11 on an enlarged scale;

FIG. 13 is a fragmentary longitudinal sectional view of the angular ball bearing assembly according to a fifth preferred embodiment of the present invention;

FIG. 14 is a fragmentary longitudinal sectional view of an important portion of the angular ball bearing assembly of FIG. 13 on an enlarged scale;

FIG. 15 is a fragmentary longitudinal sectional view of the angular ball bearing assembly according to a sixth preferred embodiment of the present invention;

FIG. 16A is a fragmentary longitudinal sectional view of an angular ball bearing assembly currently suggested;

FIG. 16B is a fragmentary longitudinal sectional view of the conventional angular ball bearing assembly;

FIG. 17 is a graph showing the relation between the propensity of temperature increase and the frictional loss, exhibited for each of regions of different quantities of a lubricant oil used in lubricating the bearing assembly;

FIG. 18 is an explanatory diagram showing the conventional air/oil supply system;

FIG. 19 is a fragmentary longitudinal sectional view of the rolling bearing assembly and a nozzle member employed in the conventional air/oil lubricating structure;

FIG. 20 is a fragmentary sectional view, showing a portion of the conventional air/oil lubricating structure of FIG. 19 on an enlarged scale;

FIG. 21A is a fragmentary longitudinal sectional view of the rolling bearing assembly in the conventional air/oil lubricating structure, showing an area of the rolling bearing assembly where the lubricant oil is insufficiently supplied;

FIG. 21B is a fragmentary longitudinal sectional view showing the suggested method of avoiding the insufficient supply of the lubricant oil;

FIG. 22 is an explanatory diagram of lubricant oil discharge passages formed in the conventional rolling bearing assembly;

FIG. 23 is an explanatory diagram of an inner race of the conventional rolling bearing assembly; and

FIG. 24 is an explanatory diagram of lubricant oil supply and discharge passages formed in the conventional angular ball bearing assembly.

### DETAILED DESCRIPTION OF THE EMBODIMENTS

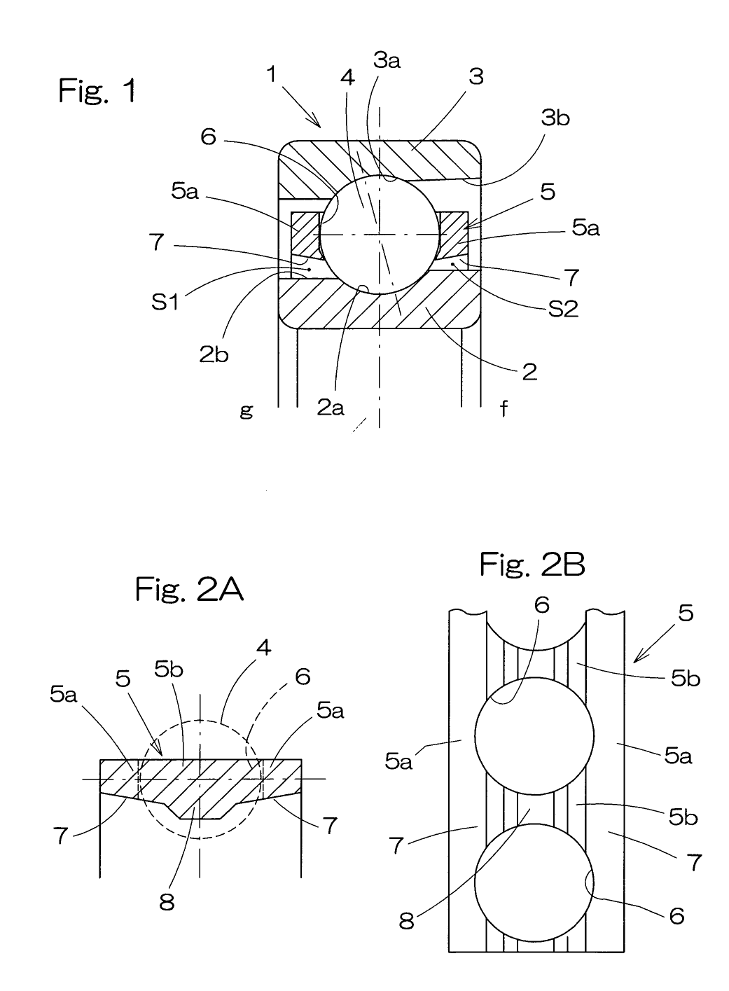

A first preferred embodiment of the present invention will now be described with particular reference to FIGS. 1 to 4.

Referring first to FIG. 1, a rolling bearing assembly 1 includes an inner race 2 having an outer peripheral surface formed with an inner raceway groove 2a, an outer race 3 having an inner peripheral surface formed with an outer raceway groove 3a in alignment with the inner raceway groove 2a, a row of rolling elements 4 rollingly accommodated in part within the inner raceway groove 2a and in part within the outer raceway groove 3a, and a retainer 5 having pockets, as will be discussed later, for accommodating the respective rolling elements 4 therein. The rolling bearing assembly 1 is in the form of an angular ball bearing assembly. Annular tapered surface areas 2b and 3b, which define a counter bore, are formed on a portion of the outer peripheral surface of the inner race 2 on one side of the inner raceway groove 2a adjacent a bearing rear side g (i.e., leftwards of the inner raceway groove 2a as viewed in FIG. 1) and on a portion of the inner peripheral surface of the outer race 3 on one side of the outer raceway groove 3a adjacent a bearing front side f (i.e., rightwards of the outer raceway groove 3a as viewed therein) of the bearing assembly 1, respectively. Each rolling element 4 is in the form of a ball made of, for example, a steel material.

As shown in FIGS. 2A and 2B, the rolling element retainer 5 is of a generally (i.e., either endless or split) ring shape including a pair of annular wing portions 5a and a plurality of pillars 5b provided therein so as to extend in an axial direction of the retainer 5 from a corresponding number of circumferential locations of the annular wing portions 5a and formed with pockets 6 between the corresponding pillars 5b for rollingly retaining the respective rolling elements 4. The pair of annular wing portions 5a is provided on both sides of the rolling element retainer 5 in an axial direction.

Respective inner peripheral surfaces of the annular wing portions 5a are axially inclined in a sense opposite to each other to define corresponding inclined annular faces 7, with the diameter of each face 7 decreasing towards a mid-center portion of the retainer 5. Each of the inclined annular faces 7 is deployed over an entire width of the corresponding annular wing portion 5a and is, in the illustrated embodiment, deployed from the corresponding annular wing portion 5a to the pillars 5b.

Also, a portion of the inner peripheral surface of each pillar 5b substantially intermediate of the axial width of the pillar 5b is provided with an intermediate carcass 8 protruding radially inwardly from the retainer 5 so that it can guide the rolling element 4. Each intermediate carcass 8 is deployed over the entire axial width of the pillar 5b and has a sectional shape along the axial direction, which represents a radially inwardly protruding, generally trapezoidal sectional shape.

Each of the inclined annular faces 7 on respective sides of the intermediate carcass 8 in the retainer 5 is preferably inclined at an angle of 10 to 20° relative to the axis of the bearing assembly 1, that is, to the axial direction of the bearing assembly 1 and has a width preferably occupying 15% or more of the entire width of the retainer 5 itself. Thus, the sum of the respective widths of the inclined annular faces 7 is 30% or more of the entire width of the retainer 5 itself. In the illustrated embodiment, the sum of the respective widths of the inclined annular faces 7 is chosen to be about 65% of the entire width of the retainer 5 itself. The retainer 5 has a guiding system, which is, for example, a metallic material. Where the retainer 5 is made of a synthetic resin, the use is preferred of, for example, a glass fiber reinforced polyamide resin as a material for the retainer 5.

Each of the pockets 6 defined in the retainer 5 is of, for example, a round shape of a diameter slightly greater than the outer diameter of the rolling elements 4. Other than the round shape, each pocket 6 may have a substantially spherical shape or a quadrate shape. Although in the illustrated embodiment the retainer 5 has been shown and described as having the pair of the annular wing portions 5a on both sides thereof, it may be of, for example, a crown type or the like having only one annular wing portion.

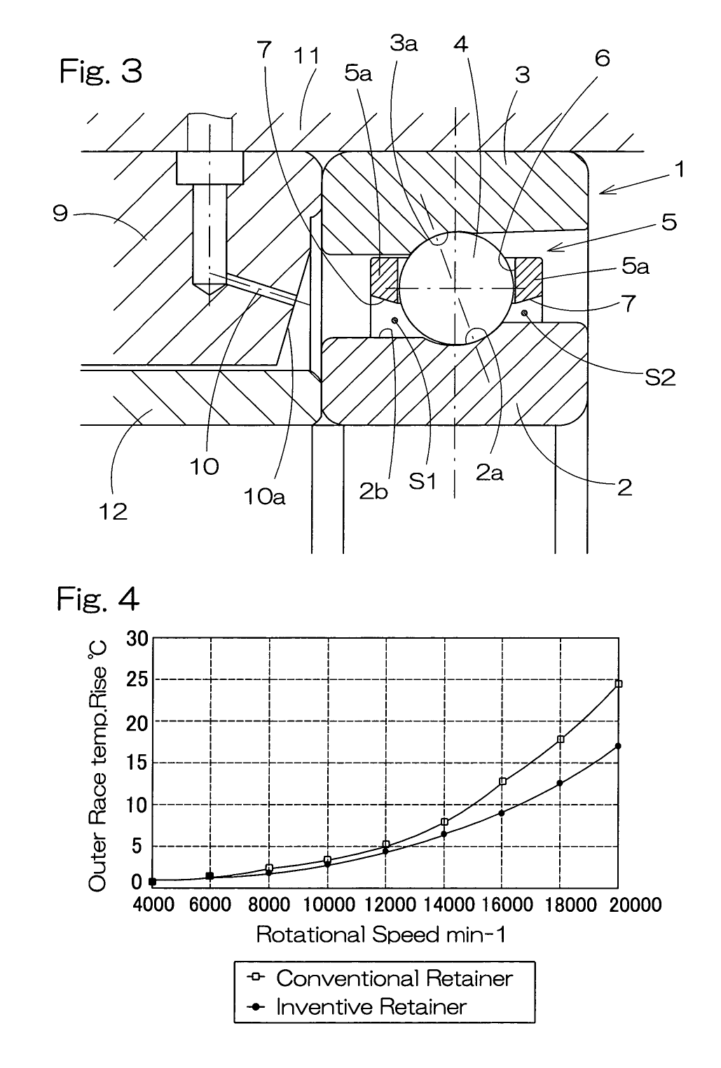

The rolling bearing assembly 1 is used in combination with a nozzle member 9 for injecting an air/oil mixture as shown in, for example, FIG. 3, and, hence, an air/oil lubricating structure is constructed by the rolling bearing assembly 1 in combination with the nozzle member 9. The nozzle member 9 is a member having a nozzle hole 10 defined therein for jetting an air/oil mixture in between the inner peripheral surface of the retainer 5 and the outer peripheral surface of the inner race 2 and is disposed at a location adjoining the outer race 3 of the rolling bearing assembly 1. This nozzle hole 10 has a discharge port 10a oriented to confront the inner raceway groove 2a of the inner race 2 and fluid-connected with a source of supply of the air/oil mixture, which may form a part of the lubricant oil supply system shown in and described with reference to FIG. 18.

An inner race spacer 12 is positioned radially inwardly of the nozzle member 9 and is slidingly held in axial abutment with the inner race 2. The nozzle member 9 is firmly inserted into a bore defined in, for example, a housing 11 accommodating the outer race 3 therein and is positioned within an annular space delimited between the housing 11 and the inner race spacer 12.

With the air/oil lubricating structure employing the rolling bearing assembly 1 of the foregoing embodiment, the following effects can be obtained. Specifically, since the inner peripheral surface of the retainer 5 is formed with the inclined annular faces 7 so inclined axially as to have their diameter decreasing towards the mid-center portion of the retainer 5, that is, to have their diameter minimized at both sides of the carcass 8, oil supply and drain spaces S1 and S2 both defined by respective parts of an annular gap between the inner peripheral surface of the retainer 5 and the outer peripheral surface of the inner race 2 can be expanded.

If the oil supply space S1 does so expand, the air/oil mixture or the like can be directed towards the inner raceway groove 2a in the inner race 2 from the nozzle hole 10 without interfering with the retainer 5, even in the case of the rolling bearing assembly 1 of a type in which the rolling elements 4 have a large diameter relative to the width of the bearing assembly 1. In such case, there is no need to lower the aiming position of the nozzle member 9 such as required in the conventional bearing assembly and, hence, there is also no need to reduce the wall thickness of the inner race spacer 12 with the inner race spacer 12 consequently having a sufficient strength.

Also, even for the oil drain space S2 defined between the inner peripheral surface of the retainer 5 and the outer peripheral surface of the inner race 2, there is no need to reduce the outer diameter of the inner race 2 and, hence, the oil drain space S2 can be expanded without being accompanied by reduction of the load bearing capability. For this reason, it is possible to suppress an undesirable accumulation of the lubricant oil within the rolling bearing assembly.

Formation of the inclined annular faces 7 in the inner peripheral surface of the retainer 5 is effective to enhance the oil supply and draining capabilities of the rolling bearing assembly 1 with no limit imposed on the design of the outer diameter of each of the inner race spacer 12 and the inner race 2. Because of this, the presence of the inclined annular faces 7 leads to increase of the operating reliability due to suppression of an undesirable temperature rise and to a high speed operation due to a low temperature rise.

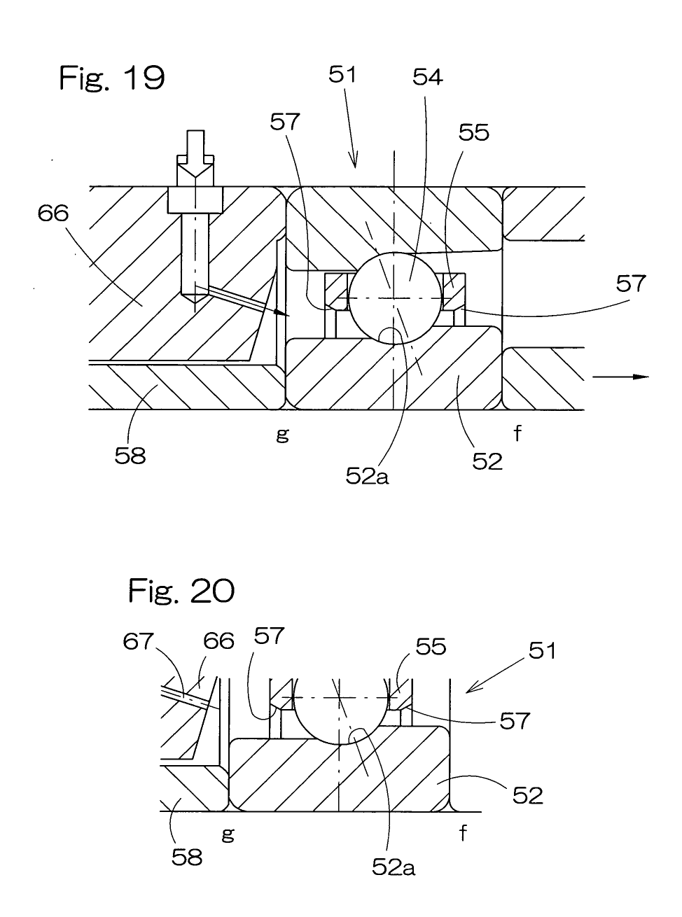

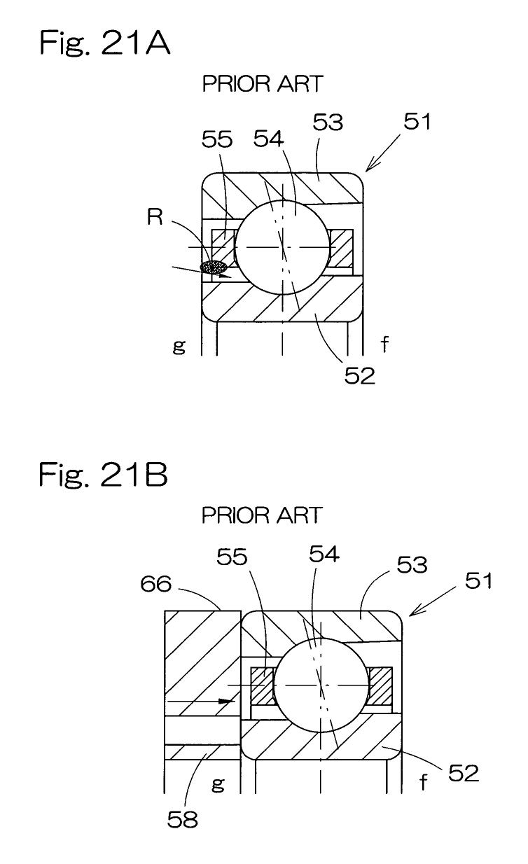

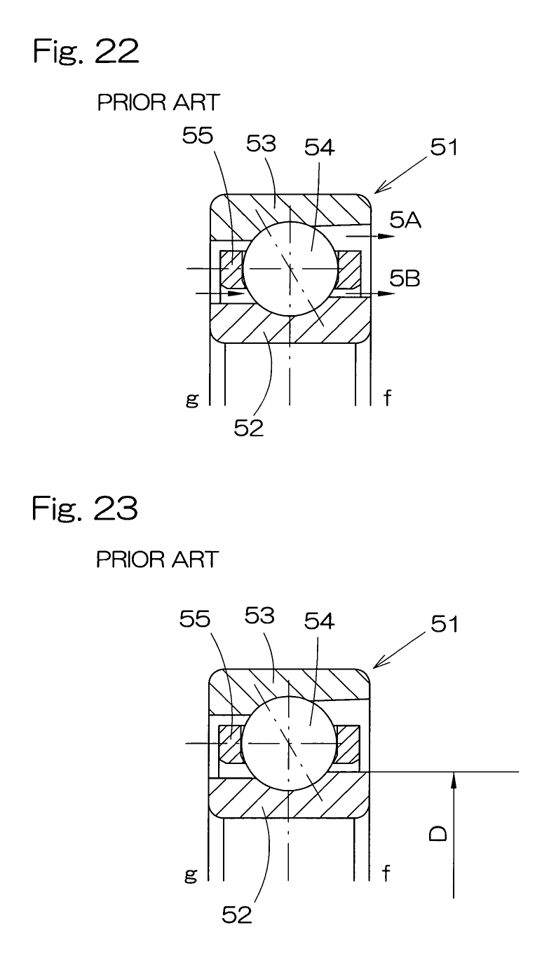

It is, however, to be noted that even where the inclined annular faces 7 are employed in the retainer 5, neither the oil supply capability nor the oil draining capability can be increased unless the inclined annular faces 7 are properly sized, and that the angle of inclination of each of the inclined annular faces 7 considerably affects the oil supply and draining capabilities. By way of example, if inclined annular faces 57 are merely formed by chamfering opposite end portions of the inner peripheral surface of the retainer 55 such as shown in FIGS. 19 and 20, each of the inclined annular faces 57 will fail to have a sufficient width and, accordingly, neither the oil supply capability nor the oil draining capability can be increased.

In contrast thereto, since in the illustrated embodiment each of the inclined annular faces 7 extends over the substantially entire width of the corresponding annular wing portion 5a, the oil supply and drain spaces S1 and S2 can be expanded to increase the oil supply and draining capabilities. As hereinbefore described, the sum of the respective widths of the inclined annular faces 7 is preferably 30% or more of the entire width of the retainer 5 itself. If the sum of the respective widths of the inclined annular faces 7 is smaller than 30% of the entire width of the retainer 5 itself, the oil supply space and the oil drain space make no difference with those employed in the conventional retainer having no inclined annular faces and, therefore, it is quite difficult to increase the oil supply and draining efficiencies.

The angle of inclination of each of the inclined annular faces 7 in the retainer 5 is preferably within the range of 10 to 20°. If this angle of inclination is not greater than the lowermost limit of 10°, the oil supply space S1 and the oil drain space S2 make no difference with those employed in the conventional retainer having no inclined annular faces 7 and, therefore, it is quite difficult to increase the oil supply and draining efficiencies. Conversely, if the angle of inclination exceeds the uppermost limit of 20°, by reason of the necessity to secure a sufficient wall thickness of the retainer 5 it would be difficult to form the inclined annular face which extends from the annular wing portion 5a to the pillars 5b, that is, the proportion of the sum of the respective widths of the inclined annular faces 7 relative to the entire width of the retainer 5 itself is reduced, and, therefore, it is difficult to expand the oil supply space S1 and the oil drain space S2.

FIG. 4 is a chart showing results of tests conducted to determine to what extent the temperature of the outer race increases in the rolling bearing assembly 1 of the foregoing embodiment of the present invention and, also, in the conventional rolling bearing assembly 51 shown in and described with reference to FIGS. 19 and 20, while the air/oil lubrication was performed during the operation of the rolling bearing assembly. The conventional rolling bearing assembly 51 is of a type, in which the rolling element retainer 55 has the inclined annular faces 57 formed merely by chamfering the opposite end portions of the inner peripheral surface of the retainer 55 and is, except for this feature, similar in structure to the rolling bearing assembly 1 shown and described in connection with the first embodiment of the present invention.

The specification of the retainers 5 and 55 and the test conditions are shown in Tables 1 and 2, respectively.

TABLE 1
Retainer Specifications

| | Retainer | Retainer |
|---|---|---|
| | 5 (FIG. 1) | 55 (FIG. 19) |
| Inclined annular faces | Employed | Employed |
| on the inner peripheral surface of | | |
| the retainer. | | |
| Angle of inclination of each | 10° | 30° |
| inclined annular face. | | |
| Proportion of the sum of the | 64% | 12% |
| widths of the inclined annular | | |
| faces relative to the entire width | | |
| of the retainer. | | |

TABLE 2
Test Conditions

| | |
|---|---|
| Bearing Tested | 7010C (50 dia. × 80 |
| | dia. × 16) |
| Lubricating Method | Air/oil Lubrication |
| Amt. of Air Supplied | 40 Nl/min. |
| Amt. of Oil Supplied | 0.03 ml/5 min./1 shot |
| Load pre-stressed during | 196 N |
| Assemblage | |

Reviewing the chart of FIG. 4, it will readily be understood that the retainer 5 of the present invention and the conventional retainer 55 have exhibited a similar temperature rise within a low and medium speed region up to 14,000 min⁻¹ (dn value=0.7 million), but within a high speed region exceeding 14,000 min⁻¹ (dn value=0.7 million) the retainer 5 according to the foregoing embodiment of the present invention has exhibited a lower temperature rise than the conventional retainer 55. The dn value represents the product of the rotational speeds times the inner diameter of the rolling bearing assembly. Except for the shape of the retainer, the rolling bearing assembly of the present invention and the conventional rolling bearing assembly are substantially identical as regards the specification and the test conditions and, hence, it may be said that the oil supply and draining capabilities brought about by the difference of the retainer 5 from the conventional retainer 55 have contributed to the low increase of the temperature.

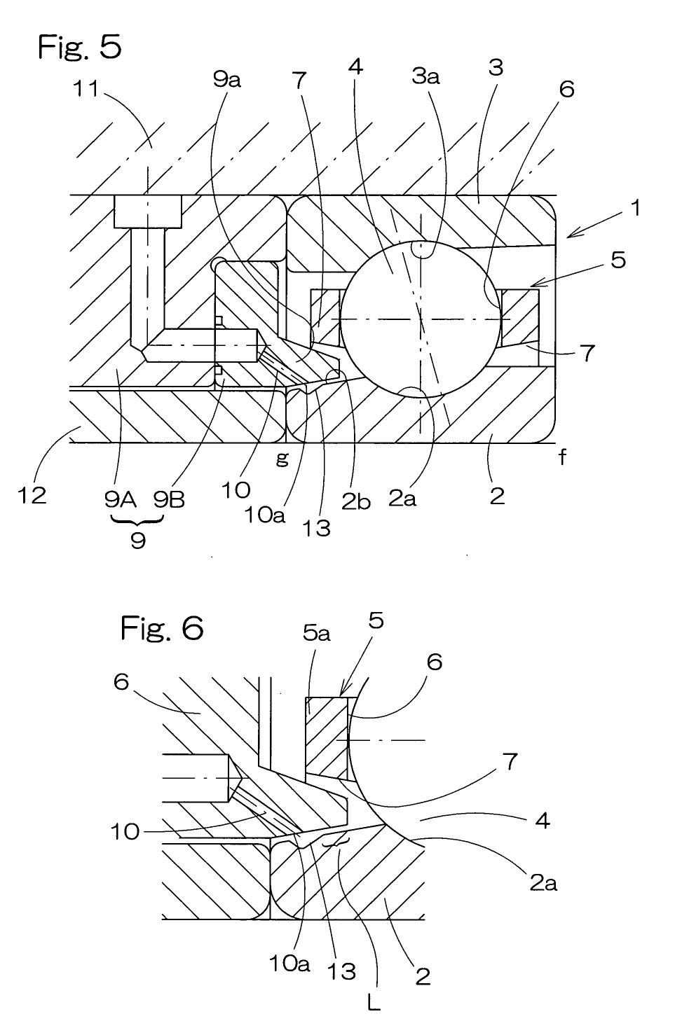

FIGS. 5 and 6 illustrate a modified form of the air/oil lubricating structure employing the rolling bearing assembly shown and described in connection with the foregoing embodiment. In this modification, the nozzle member 9 includes a nozzle hole defining projection 9a, which protrudes in between the inner peripheral surface of the retainer 5 and the outer peripheral surface of the inner race 2, with the nozzle hole 10 defined in the nozzle hole defining projection 9a. The nozzle hole 10 has a discharge port 10a opening in a portion of the nozzle hole defining projection 9a, which confronts a portion of the outer peripheral surface of the inner race 2. That portion of the inner race 2 to which the nozzle hole defining projection 9a protrudes is defined as the annular tapered surface area 2b, and a minute gap is formed between the nozzle hole defining projection 9a and the annular tapered surface area 2b of the inner race 2. A portion of the annular tapered surface area 2b of the inner race 2, which confronts the nozzle discharge port 10a, is formed with a circumferentially extending V-shaped groove 13.

It is to be noted that although the nozzle member 9 is shown as divided into a nozzle body 9A and a projection forming member 9B having the nozzle hole defining projection 9a, the nozzle member 9 may be of one-piece construction including the nozzle body 9A and the projection forming member 9B.

According to the modification shown in and described with reference to FIGS. 5 and 6, the lubricant oil discharged from the nozzle hole 10 onto the annular tapered surface area 2b in the inner race 2 can flow towards the inner raceway groove 2a while keeping a contact with the annular tapered surface area 2b by the effect of a surface tension and a centrifugal force developed as a result of rotation of the inner race 2 relative to the outer race 3. Considering that the presence of the inclined annular face 7 on the inner peripheral surface of the retainer 5 expands the space delimited between it and the annular tapered surface area 2b, the nozzle hole defining projection 9a of the nozzle member 9 can protrude deep into such space. Because of this, as shown in FIG. 6 on an enlarged scale, the annular region as indicated by L in which the nozzle hole defining projection 9a confronts a portion of the annular tapered surface area 2b can axially extends a substantial distance and, owning to this, the lubricant oil can exhibit a favorable attachment flow, accompanied by increase of the lubricity.

Specifically, if the region L extends a small distance, a favorable attachment of the lubricant oil to the annular tapered surface area 2b in the inner race 2 will not occur, involving a considerable risk of being scattered by the effect of the centrifugal force. Accordingly, if the nozzle hole defining projection 9a is allowed to protrude as deep as possible into that space between it and the annular tapered surface area 2b to thereby secure the region L extending as large a distance as possible, the possibility of the lubricant oil being scattered by the effect of the centrifugal force can advantageously be avoided, allowing the proportion of the lubricant oil, effectively supplied onto the inner raceway groove 2a, to be increased.

In describing the foregoing embodiment of the invention including the modification made to it, reference has been made to the angular ball bearing assembly. It is, however, to be noted that the rolling bearing assembly 1 and the rolling element retainer 5, both constructed in accordance with the present invention, can be equally applied to any of a deep groove ball bearing assembly and a roller bearing assembly and, even in such case, the oil supply and draining capabilities can be increased.

Also, the material for the retainer 5 and the guiding system employed thereby are not specifically limited to those described hereinabove, and the oil supply and draining capabilities can be increased, provided that the retainer has the inclined annular faces 7 on the inner peripheral surface thereof as discussed in detail hereinabove.

Furthermore, the effects brought about by the presence of the inclined annular faces 7 can be equally appreciated not only when the air/oil lubricating is employed as hereinabove described, but when the oil mist lubricating or any other oil lubricating is employed.

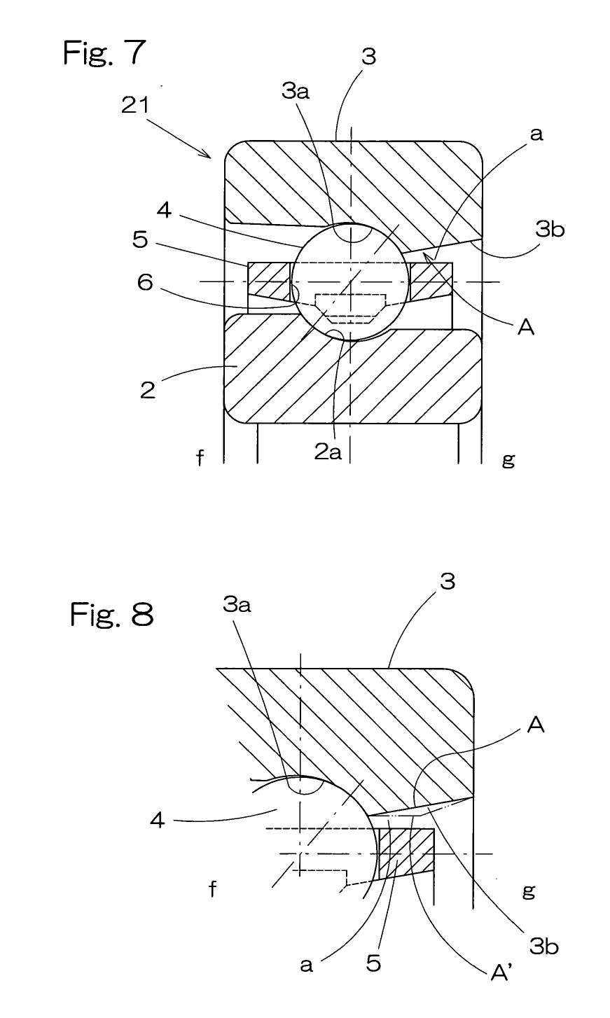

FIGS. 7 and 8 illustrate a second preferred embodiment of the present invention. In this embodiment, the angular ball bearing assembly 21 is of a design in which the roller element retainer 5 for rollingly retaining the rolling elements 4 in the pockets 6 is employed and the rolling elements 4 are operatively received in part within the inner raceway groove 2a in the inner race 2 and in part within the outer raceway groove 3a in the outer race 3. The rolling elements 4 are each in the form of a ball.

A portion of the inner peripheral surface of the outer race 3 on one side of the outer raceway groove 3a adjacent a bearing rear side g is formed in its entirety as an annular tapered surface area 3b having a diameter gradually increasing towards the bearing rear side g. It is, however, to be noted that that portion of the inner peripheral surface of the outer race 3 adjacent the bearing rear side g need not be formed in its entirety as the annular tapered surface area 3b, provided that at least a shoulder portion A closely adjacent to the outer raceway groove 3a, that is, a portion of the inner peripheral surface adjacent the outer raceway groove 3a is formed as an annular tapered surface area 3b having a diameter increasing towards the bearing rear side g. In the example shown in FIG. 8, for the purpose of comparison with the conventional rolling bearing assembly, a portion of the inner peripheral surface of the outer race employed in the conventional rolling bearing assembly, which functionally corresponds to the annular tapered surface area 3b, is shown by the double-dotted line. As shown by the double-dotted line in FIG. 8, that portion of the inner peripheral surface of the outer race employed in the conventional rolling bearing assembly is tapered at a location remote from the outer raceway groove and adjacent an rear end face of the outer race, but that portion of the inner peripheral surface adjacent the outer raceway groove, i.e., a shoulder portion shown by A′ remains cylindrical.

Since in this angular ball bearing assembly 21 of the structure described above the shoulder portion A of the inner peripheral surface of the outer race 3 is formed as the annular tapered surface area 3b having a maximum diameter at the rear end face of the outer race 3, where lubrication with a lubricant oil takes place, a gap a delimited between the annular tapered surface area 3b and the retainer 5 at the rear side g of the outer race 3 increases as can be readily understood by the comparison with the conventional case shown by the double-dotted line in FIG. 8. Because of this, the lubricant oil flowing into the inside of the rolling bearing assembly can easily be drained through the gap a and, accordingly, the amount of the lubricant oil accumulating within the rolling bearing assembly and apt to be stirred can advantageously be reduced to thereby minimize heat generation resulting from the stirring of the lubricant oil.

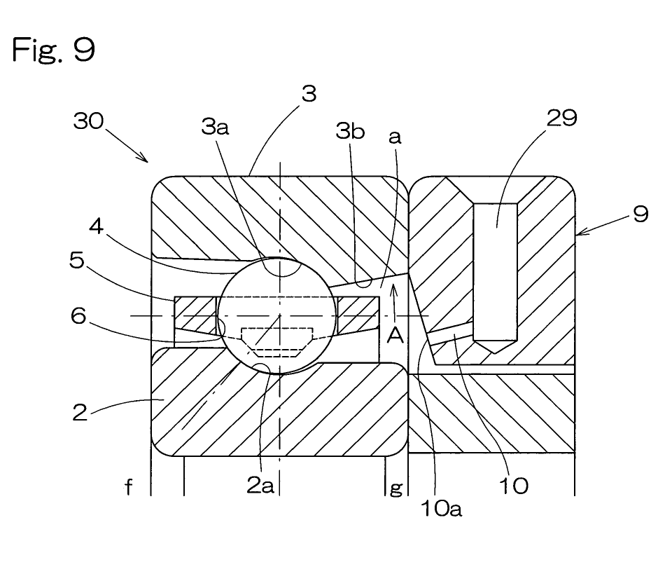

Referring to FIG. 9, there is shown a nozzle-equipped angular ball bearing assembly 30 in accordance with a third preferred embodiment of the present invention. The nozzle-equipped angular ball bearing assembly 30 is made up of the angular ball bearing assembly 21 of FIGS. 7 and 8 and the nozzle member 9 for supplying a lubricant oil onto the outer peripheral surface of the inner race 2. Adjacent the angular ball bearing assembly 21 is the nozzle member 9 fixedly disposed on an inner peripheral surface of the housing (not shown) that accommodates the outer race 3 of the angular ball bearing assembly 21. This nozzle member 9 includes a nozzle hole 10 having a nozzle discharge port 10a opening towards a portion of the outer peripheral surface of the inner race 2 adjacent the bearing rear side g, that is, adjacent the bearing front side of the inner race 2. The nozzle hole 10 is defined in the nozzle member 9 at one location or a plurality of locations spaced in a direction circumferentially of the nozzle member 9. An inlet port of the nozzle hole 10 is fluid-connected with a source of supply of the lubricant oil (not shown) through an oil supply passage 29 so defined in the housing as to extend from the nozzle member 9.

According to the third embodiment of the present invention, the lubricant oil supplied from the nozzle member 9 is jetted onto that portion of the outer peripheral surface of the inner race 2 of the angular ball bearing assembly 21 to efficiently lubricate the inside of the bearing assembly 21. Since, as hereinabove described, the presence of the annular tapered surface area 3b adjacent the bearing rear side g facilitates the drainage of the lubricant oil from the gap a delimited between the outer race 3 and the retainer 5, the heat generation resulting from the stirring of the lubricant oil can advantageously be suppressed to thereby increase the lubricity.

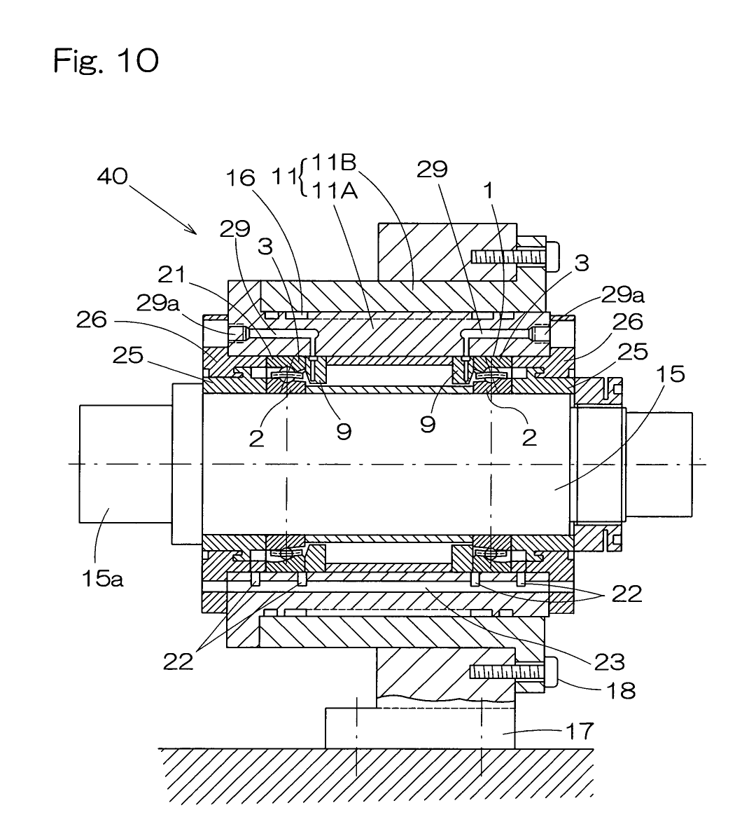

Referring now to FIG. 10, there is shown a spindle device 40 utilizing the angular ball bearing assembly 21 of FIG. 7. The spindle device 40 is generally utilized in machine tools and includes a spindle 15 having one end 15a to which a chuck of a tool or a work is mounted. This spindle 15 is rotatably supported by a plurality of, for example, two, axially spaced angular ball bearing assemblies 21, and the nozzle member 9 of FIG. 9 is disposed in the vicinity of each of the angular ball bearing assemblies 21.

Each of the angular ball bearing assemblies 21 has an inner race 2, mounted on an outer peripheral surface of the spindle 15, and an outer race 3 press-fitted into the bearing bore defined in the housing 11. The inner and outer races 2 and 3 are retained in position within the housing 11 by means of a corresponding inner race retainer 25 and a corresponding outer race retainer 26, respectively. The housing 11 is of two-piece construction made up of a radially inner housing component 11A and a radially outer housing component 11B mounted on the inner housing component 11A with a coolant passage 16 defined between those housing components 11A and 11B.

The oil supply passage 29 previously referred to with reference to FIG. 9 is defined in the inner housing component 11A and has an oil inlet port 29a at one end thereof. The housing 11 is supported on a support bench 17 and is fixed in position by one or more bolts 18. Also, the housing 11 has a plurality of, for example, two oil discharge grooves 22 defined in a portion of the inner peripheral surface thereof adjacent the respective angular ball bearing assembly 21, which grooves 22 are in turn communicated with a common drain passage 23, defined axially in the inner housing component 11A, for the discharge of the lubricant oil to the outside of the spindle device 40.

With the spindle device 40 so constructed as hereinabove described, the angular ball bearing assemblies 21 having an excellent capability of suppressing the heat generation are utilized to rotatably support the spindle 15 of the spindle device 40 for the machine tools and, therefore, the spindle 15 can be allowed to rotate at a high speed without accompanying an undesirable reduction in machining precision which would otherwise occur as a result of the heat generation.

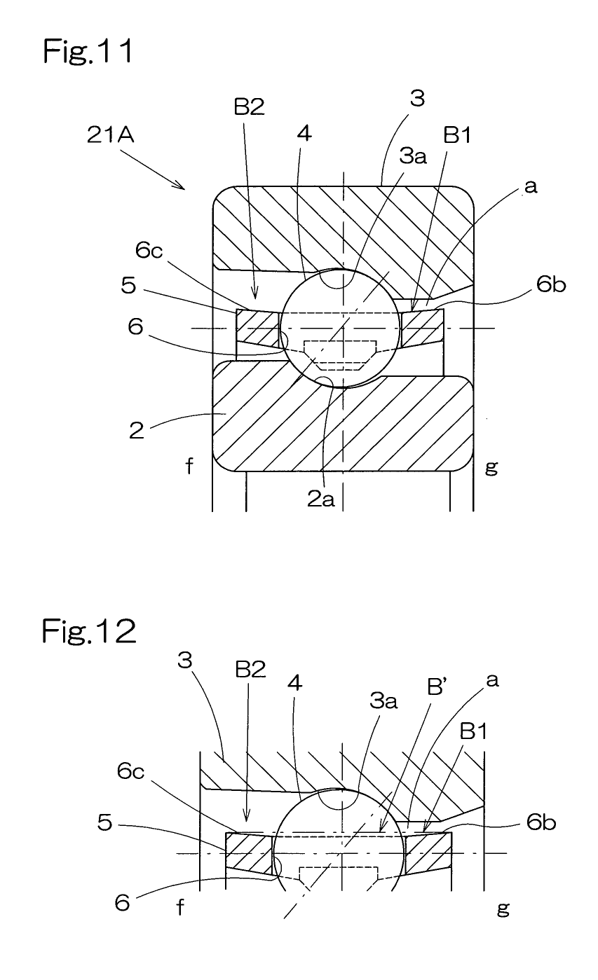

A fourth preferred embodiment of the present invention will now be described with particular reference to FIGS. 11 an 12. The rolling bearing assembly shown therein is an angular ball bearing assembly 21A similar in structure to the angular ball bearing assembly 21 (FIG. 7) of the second embodiment of the present invention.

However, the angular ball bearing assembly 21A differs from the angular ball bearing assembly 21 in that, in place of the annular tapered surface area 3b formed in the shoulder portion A of the inner peripheral surface of the outer race 3 shown in FIG. 7, a portion B1 of the outer peripheral surface of the retainer 5 on one side of each pocket-formed portion (or a circumferential portion in which the pockets are formed and having a width corresponding to a pocket diameter) adjacent the rear side g of the outer race 3 and a portion B2 of the outer peripheral surface of the retainer 5 on the opposite side of the respective pocket-formed portion adjacent the bearing front side f of the outer race 3 are each formed as an annular tapered surface area 6b and 6c that is axially outwardly flared to have a diameter increasing towards the corresponding annular end of the retainer 5. Formation of the annular tapered surface areas 6b and 6c on the respective portions of the outer peripheral surface of the retainer 5 allows the outer peripheral surface of the retainer 5 to have a intermediate portion moderately depressed radially inwardly.

Other structural features of the angular ball bearing assembly 21A than those described above are similar to those of the angular ball bearing assembly 21 of the structure according to the second embodiment. For the purpose of comparison with the conventional angular ball bearing assembly, the contour of the outer peripheral surface B′ of the retainer employed in the conventional angular ball bearing assembly is shown by the double-dotted line in FIG. 12.

Since, in this angular ball bearing assembly 21A of the structure described above where lubrication with a lubricant oil takes place, the portion B1 of the outer peripheral surface of the retainer 5 adjacent the rear side g of the outer race 3 is formed to define the annular tapered surface area 6b that is flared axially outwardly to have a diameter increasing towards the corresponding annular open end of the retainer 5 and, hence, to have a reduced outer diameter at the intermediate portion of the retainer 5, a gap a delimited between the inner peripheral surface of the outer race 3 and the annular tapered surface area 6b and positioned adjacent the rear side g of the outer race 3 can have an increased capacity as compared with that in the conventional angular ball bearing assembly. Accordingly, the lubricant oil can be easily drained through this gap a, minimizing the amount of the lubricant oil accumulating within the bearing assembly to thereby suppress the heat generation which would otherwise result from the stirring of the lubricant oil.

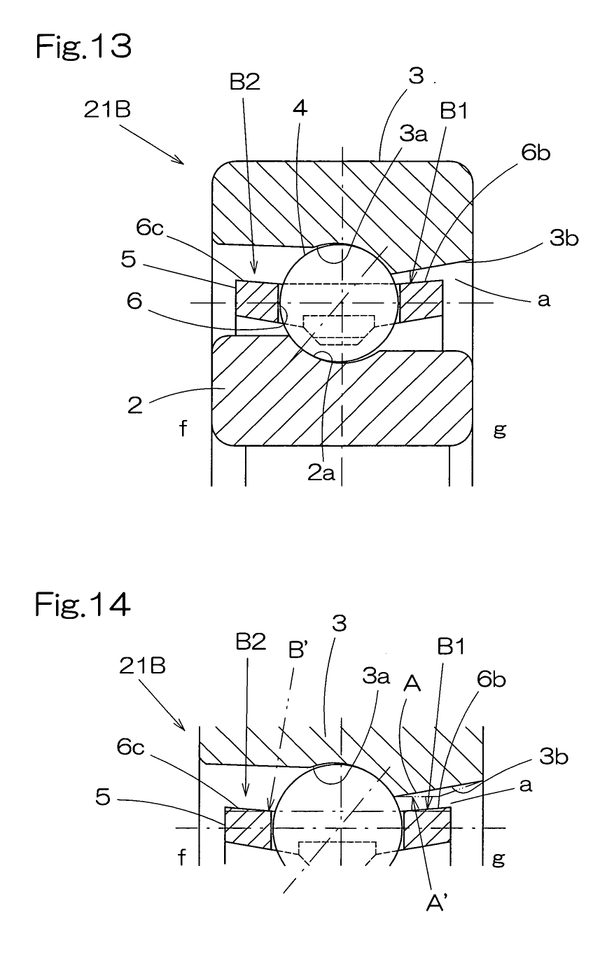

FIGS. 13 and 14 illustrates an angular ball bearing assembly 21B according to a fifth preferred embodiment of the present invention. The angular ball bearing assembly 21B is similar in structure to the angular ball bearing assembly 21 according to the second embodiment, but differs therefrom in that a portion B1 of the outer peripheral surface of the retainer 5 on one side of each pocket-formed portion adjacent the rear side g of the outer race 3 and a portion B2 of the outer peripheral surface of the retainer 5 on the opposite side of the respective pocket-formed portion adjacent the front side f of the outer race 3 are each formed as an annular tapered surface area 6b and 6c that is axially outwardly flared to have a diameter increasing towards a corresponding annular end of the retainer 5. Formation of the annular tapered surface areas 6b and 6c on the respective portions of the outer peripheral surface of the retainer 5 allows the outer peripheral surface of the retainer 5 to have an intermediate portion moderately depressed radially inwardly.

In other words, a shoulder A (FIG. 7) of the inner peripheral surface of the outer race 3 is formed to define the annular tapered surface area 3b and, on the other hand, those portions B1 and B2 of the outer peripheral surface of the retainer 5 are formed to define the respective annular tapered surface areas 6b and 6c.

Other structural features of the angular ball bearing assembly 21B than those described above are similar to those of the angular ball bearing assembly 21 of the structure according to the second embodiment. For the purpose of comparison with the conventional angular ball bearing assembly, the shoulder portion A′ of the inner peripheral surface of the outer race and the outer peripheral surface B′ of the outer peripheral surface of the retainer, both employed in the conventional bearing assembly, which correspond to the annular tapered surface areas 3b, 6b and 6c employed in the practice of the present invention, respectively, are shown by the double-dotted lines in FIG. 14.

In the angular ball bearing assembly 21B of the structure described above, the shoulder portion A of the inner peripheral surface of the outer race 3 adjacent the outer raceway groove with respect to the bearing rear side g is formed to define the annular tapered surface area 3b that is axially outwardly flared to have a diameter increasing towards the corresponding open end of the outer race 3 and, therefore, the gap a delimited between the outer race 3 and the retainer 5 at a location adjacent the bearing rear side g can advantageously be increased in size. Along therewith, that portion B1 of the outer peripheral surface of the retainer 5 adjacent the rear side g of the outer race 3 is similarly formed to define the annular tapered surface area 6b that is axially outwardly flared to have a diameter increasing towards the annular open end of the retainer 5 and, therefore, the inner peripheral surface of the outer race 3 and the outer peripheral surface of the retainer 5 confront with each other at a location adjacent the rear side g of the outer race 3, being spaced from each other a distance delimited between the respective annular tapered surface areas 3b and 6b that are inclined in the same direction.

In view of the foregoing features, this embodiment of FIGS. 13 and 14 allows the retainer 5 to have a relatively large outer diameter and, hence, to have a sufficient rigidity and, at the same time, the gap a between the outer race 3 and the retainer 5 can be increased to enhance the drainage of the lubricant oil through such gap a. Accordingly, the heat generation resulting from the stirring of the lubricant oil can advantageously be suppressed and, at the same time, the rigidity can advantageously be secured in the retainer 5.

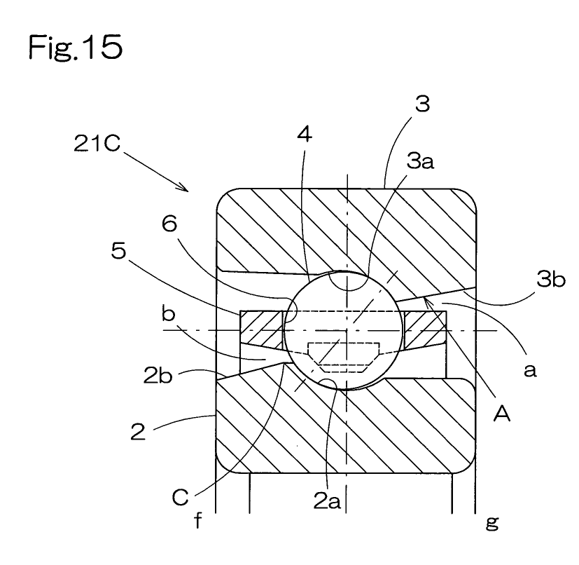

An angular ball bearing assembly 21C according to a sixth preferred embodiment of the present invention will now be described with particular reference to FIG. 15. Referring to FIG. 15, the angular ball bearing assembly 21C is similar to the angular ball bearing assembly 21 of the second embodiment, except that one end portion of the outer peripheral surface of the inner race 2 on one side of the inner raceway groove 2a adjacent the bearing front side f (a rear side of the inner race) is formed to define an annular tapered surface area 2b that is flared axially outwardly to have a diameter decreasing towards the corresponding annular end of the inner race 2. This annular tapered surface area 2b may be formed over the entire outer peripheral surface of the inner race 2 on one side of the inner raceway groove 2a adjacent the bearing front side f. However, in the illustrated embodiment, a shoulder portion C adjacent the inner raceway groove 2a in the inner race 2 is left to represent a cylindrical shape, while the remaining portion of the outer peripheral surface of the inner race 2 adjacent the bearing front side f is tapered to define the annular tapered surface area 2b.

According to the sixth embodiment of FIG. 15, where the annular tapered surface area 2b is formed in the outer peripheral surface of the inner race 2 as hereinabove described, the inflow characteristic of the lubricant oil into the bearing assembly can be advantageously increased when the lubricant oil is supplied from the bearing front side f. Accordingly, in combination of the lubricant oil draining capability enhanced by the formation of the shoulder portion A of the inner peripheral surface of the outer race 3, which portion A is formed to define the annular tapered surface area 3b, the lubricity can advantageously be increased further.

Other structural features of the angular ball bearing assembly 21C than those described above are similar to those of the angular ball bearing assembly 21 of the second embodiment.

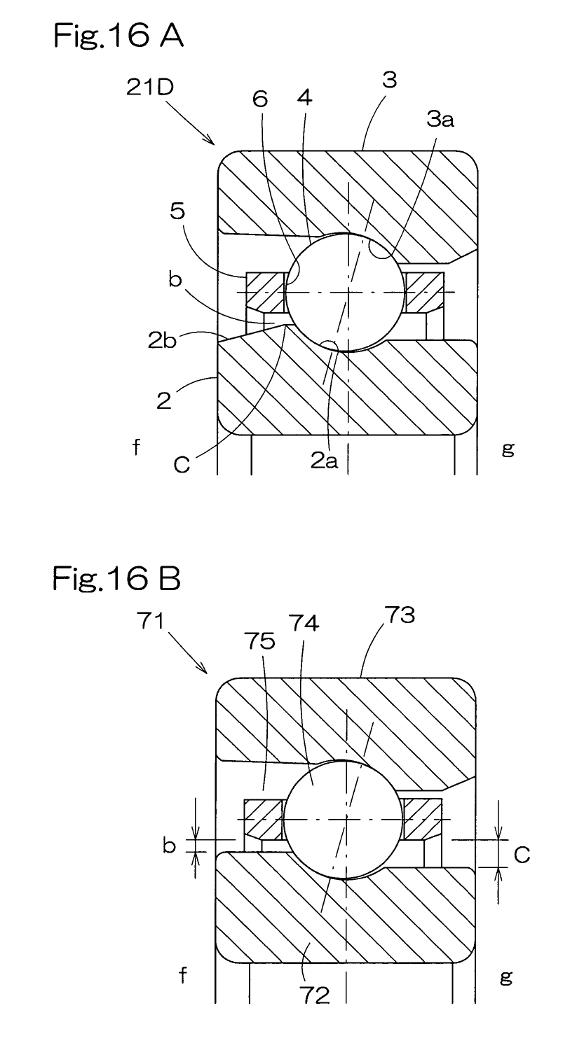

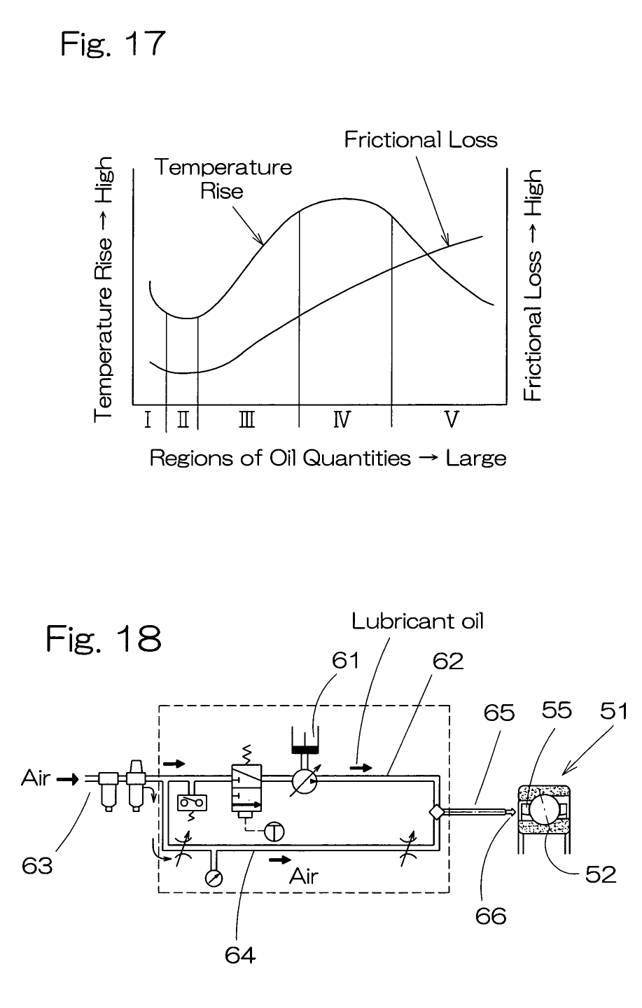

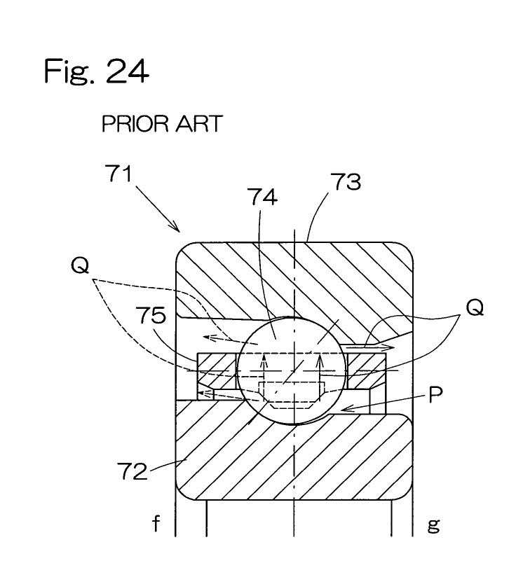

FIG. 16A illustrates an angular ball bearing assembly 21D which is suggested for reference purpose. The illustrated angular ball bearing assembly 21D is similar to the angular ball bearing assembly 21C of the sixth embodiment shown in FIG. 15, but differs therefrom in that the shoulder portion A of the inner peripheral surface of the outer race 3, which is formed to define the annular tapered surface area 3b in the sixth embodiment as described above, is formed to define a cylindrical surface area at a location adjacent the outer raceway groove 3a and also an annular tapered surface area at a location remote from the outer raceway groove 3a but adjacent the rear annular end of the outer race 3, and continued from the cylindrical surface area. In other words, the outer race 3 employed in the angular ball bearing assembly 21D is similar to that the conventional bearing assembly shown in FIG. 24, but a portion of the outer peripheral surface of the inner race 2 on one side of the inner raceway groove 2a adjacent the bearing front side f (the rear side of the inner race) is formed to define the annular tapered surface area 2b that is flared axially outwardly to have a diameter decreasing towards the corresponding annular end of the inner race 2.

Other structural features of the angular ball bearing assembly 21D than those described above are similar to those of the angular ball bearing assembly 21C of the sixth embodiment shown in FIG. 15.

In the angular ball bearing assembly 21D, since that portion of the outer peripheral surface of the inner race 2 adjacent the bearing front side f is formed to define the annular tapered surface area 2b, a gap b delimited between the inner peripheral surface of the retainer 5 and the annular tapered surface area 2b in the inner race 2 at a location adjacent the bearing front side f can advantageously be increased in size. Therefore, even when the nozzle member 9 such as shown in FIG. 9 is disposed in the close vicinity of the bearing front side f, the lubricant oil supplied from the nozzle member 9 can be sufficiently supplied deep into the bearing assembly. Also, since a grooved shoulder portion of the inner raceway groove 2a adjacent the bearing front side f (the rear side of the inner race), which serves as a load receiving side of the inner race 2, can have a sufficient strength.

Comparison will now be made with the standard angular ball bearing assembly 71 with the retainer built therein as shown in FIG. 16B. In the standard angular ball bearing assembly 71, the outer diameter of the inner race 72 can be reduced adjacent the bearing rear side g (the front side of the inner race) since no load is imposed on the inner race 72 on the bearing rear side g. However, since a load is imposed on the inner race 72 on the bearing front side f, the inner race is designed to have an increased outer diameter on the bearing front side f so that the dimensions of grooved shoulder of the inner raceway groove can be secured. For this reason, at the bearing front side f, the gap b between the inner peripheral surface of the retainer 75 and the outer peripheral surface of the inner race 72 tends to become small as compared with the gap c at the bearing rear side g (gap c) and, therefore, nozzle oiling from the bearing front side f fails to supply a sufficient quantity of the lubricant oil into the bearing assembly. Such problem can be resolved by the formation of the annular tapered surface area 2b in the outer peripheral surface of the inner race 2 such as shown in FIG. 16A.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. For example, in describing the embodiment of FIG. 9, the angular ball bearing assembly 30 has been described as a version of the angular ball bearing assembly 21 according to the embodiment of FIG. 7 equipped with the nozzle member 9 that is disposed in the close vicinity of such angular ball bearing assembly 21. However, the nozzle member 9 of the specific construction can be equally employed in combination with any one of the angular ball bearing assemblies 21A to 21C shown in and described with reference to FIGS. 11 to 15, respectively.

Also, in describing the spindle device 40 shown in FIG. 10, the spindle device 40 has been described as used in combination with the angular ball bearing assembly 21 equipped with the nozzle member 9. However, the spindle device 40 can be equally used in combination with any one of the angular ball bearing assemblies 21A to 21C shown in and described with reference to FIGS. 11 to 15, with or without the nozzle member 9 employed concurrently.

Accordingly, such changes and modifications are, unless they depart from the scope of the present invention as delivered from the claims annexed hereto, to be construed as included therein.

1. A retainer for a rolling bearing assembly, which comprises:
an annular wing portion; and
a plurality of pillars extending in an axial direction of the retainer from a corresponding number of circumferential locations of the annular wing portion and formed with a pocket between the neighboring pillars for rollingly retaining rolling elements of the rolling bearing assembly;
wherein the annular wing portion has an inner peripheral surface formed to define an inclined annular face and wherein the inclined annular face is deployed over a first substantially entire width of the annular wing portion in the axial direction and is inclined to have a diameter decreasing towards a mid-center portion of the retainer in the axial direction.

2. The retainer for the rolling bearing assembly as claimed in claim 1, further comprising a second annular wing portion positioned opposite to the first annular wing portion with respect to the axial direction and having a second inclined annular face and wherein the second inclined annular face is deployed over a second substantially entire width of the second annular wing portion in the axial direction and is inclined to have a diameter decreasing towards the mid-center portion of the retainer.

3. The retainer for the rolling bearing assembly as claimed in claim 1, wherein the inclined annular face is inclined at an angle within the range of 10 to 20°.

4. The retainer for the rolling bearing assembly as claimed in claim 1, wherein the sum of the first and second widths occupies 30% or more of the entire width of the retainer.

5. A rolling bearing assembly, which comprises:
an outer race;
an inner race positioned inside the outer race;
a circular row of rolling elements rollingly interposed between the outer race and the inner race; and
a retainer of a structure as defined in claim 1 for rollingly retaining the rolling elements.

6. A lubricating structure for a rolling bearing assembly, which comprises:
the rolling bearing assembly including an outer race, an inner race positioned inside the outer race, a circular row of rolling elements rollingly interposed between the outer race and the inner race and a retainer of a structure as defined in claim 1 for rollingly retaining the rolling elements; and
a nozzle member for injecting a lubricant oil such as an air/oil mixture or an oil mist in between an inner peripheral surface of the retainer and an outer peripheral surface of the inner race.

7. An angular ball bearing assembly, which comprises:
an outer race having an outer raceway groove defined in an inner peripheral surface thereof;
an inner race positioned inside the outer race and having an inner raceway groove defined in an outer peripheral surface thereof;
a circular row of rolling elements rollingly received in part within the outer raceway groove and in part within the inner raceway groove; and
a retainer interposed between the outer and inner races for rollingly retaining the rolling elements;
wherein at least one of a shoulder portion of the inner peripheral surface of the outer race on one side of the outer raceway groove adjacent a rear side of the outer race and a portion of an outer peripheral surface of the retainer on one side of each pocket adjacent the rear side of the outer race is formed to define an annular tapered surface area flaring axially outwardly towards an annular open end of the outer race, with the diameter of the annular tapered surface area increasing towards the annular open end of the outer race.

8. The angular ball bearing assembly as claimed in claim 7, which is used for rotatably supporting a spindle of a machine tool spindle device.

9. The angular ball bearing assembly as claimed in claim 7, further comprising a nozzle member disposed on a front side of the angular ball bearing assembly for supplying a lubricant oil onto the outer peripheral surface of the inner race.
